(19) United States
(12) Patent Application Publication
(10) Pub. No.: US 2022/0183931 A1
(43) Pub. Date: Jun. 16, 2022

(54) REFLECTIVE CHILD COMFORTER

(71) Applicants: Sung Hei Yau, Malden, MA (US); Fangting Yu, Malden, MA (US)

(72) Inventors: Sung Hei Yau, Malden, MA (US); Fangting Yu, Malden, MA (US)

(21) Appl. No.: 17/119,291

(22) Filed: Dec. 11, 2020

(51) Int. Cl. A61J 17/00

(52) U.S. Cl. CPC A61J 17/109; A61J 17/001

(57) ABSTRACT

A reflective child comforter is disclosed, including a child comforter including a front side having a button and a shield. A reflective material is arranged to reflect infrared light from at least a part of the front side. An elongated teat protrudes from the back side to permit chewing or suckling.

### TECHNICAL FIELD

The embodiments generally relate to baby comforters and, more particularly, relate to pacifiers and teethers which incorporate a reflective material.

### BACKGROUND

Comforters, such as pacifier or teethers are widely used tool for calming a child and may also reduce instances of sudden infant death syndrome (SIDS) in young infants. During the nighttime, a pacifier is commonly used to calm a waking child or help prepare a child for sleep; however, when a pacifier is used at night, there is a high chance that the pacifier will be lost in the child's sleeping area.

In recent years, baby monitors with video capability have become common. Many baby monitors include a night mode feature which utilizes an infrared camera and allows the baby and the surrounding environment to be viewed in low light settings. While the current use of the infrared camera can help monitor the well-being of a child in a dimly lit environment, it cannot aid in the location of the pacifier, which is especially challenging in the dark, as most pacifiers are made with transparent materials.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a reflective child comforter, including a front side having a button and a shield. A reflective material is arranged to reflect infrared light from at least a part of the front side. An elongated teat protrudes from the back side to permit chewing or suckling.

The child comforter is configured as a pacifier or a teether that has reflective properties, which allows for quick identification and location when viewed through an infrared camera. The child comforter includes a reflective material arranged to reflect light to enable the pacifier to be viewed when viewing the display of a baby monitor during low-light conditions.

In one aspect, the reflective material is reflective in the infrared spectrum.

In one aspect, the pacifier is a three-piece pacifier or a single piece pacifier.

In one aspect, the reflective material is positioned on the shield and/or on the button. The reflective material may cover the entire front side or only a portion.

In one aspect, the reflective material is applied using an adhesive to the front side.

In one aspect, the reflective material is embedded into the child comforter as a reflective panel or as a dye.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the child comforter having a reflective material, according to some embodiments;

FIG. 2 illustrates a cross-section view of the child comforter having an embedded reflective material, according to some embodiments; and

FIG. 3 illustrates a perspective view of child comforter positioned in the child's mouth, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

In general, the embodiments describe a child comforter, specifically a pacifier or a teether that has reflective properties which allows for quick identification and location when viewed through a camera. The child comforter includes a reflective material arranged to reflect light to enable the pacifier to be viewed when viewing the display of a baby monitor.

The child comforter may include various pacifier and/or teether configurations. For example, the pacifier may include common single piece silicon type or multi piece design. The inclusion of the reflective material can be a graphic print made with reflective paint or pigment. The reflective material can also be incorporated in the pacifier material, such as polymers, plastics or silicone using reflective pigments or dyes. The reflective material can be confined or encapsuled in a transparent material, such as a coating or in a layered structure.

The current use of an infrared baby monitor along with a comforter with reflective materials allows the comforter to be identified by reflected infrared light emitted from the camera, which highlights the location of the comforter when it is in the line of sight of the camera.

As used herein, the term “reflective” relates to a material property that allows for light incident upon the subject to be partially or fully reflected back at the source. Reflective materials can reflect light across the spectrum and are not limited in wavelength.

As used herein, the term “infrared” relates to light with a wavelength longer that the visible spectrum but shorter than microwave. For example, light having a wavelength spanning between 700 nm to 1 mm.

As used herein, the term “pacifier” relates to a rubber, plastic, or silicone nipple substitute given to an infant to suckle upon, which can comfort a distressed child by satisfying the need to suckle.

As used herein, the term “teether” relates to a chewable toy or object for infants during teething and provides relief during teething. Compared to pacifiers, teethers are meant to be chewed rather than suckled.

The terms “pacifier” and “teether” may be collectively referred to as “comforter(s)” or “child comforter(s)”.

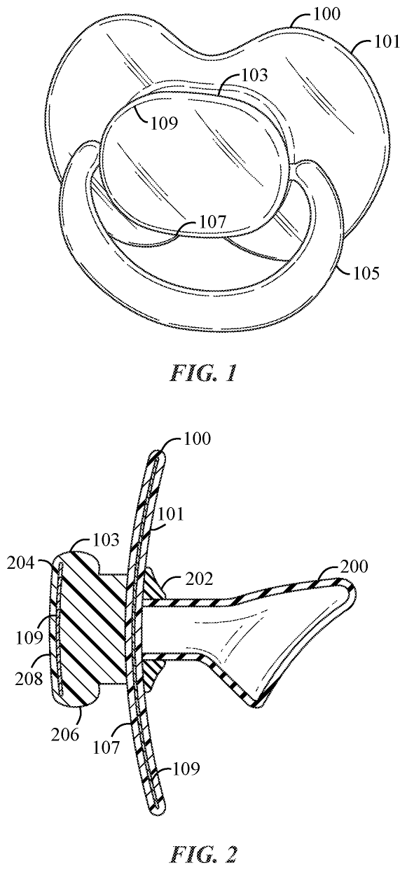

FIG. 1 illustrates the child comforter 100 in an exemplary embodiment wherein the child comforter 100 is configured as a three-piece or a single piece pacifier or teether. The child comforter 100 includes a shield 101, a button 103, a handle 105, and an elongated teat (shown in FIG. 2). The shield 101, button 103, and handle 105 comprise the front side 107 of the child comforter 100 and are visible when in use. A reflective material 109 is applied to the child comforter to make the child comforter 100 visible on the display of a baby monitor which uses an infrared camera. This allows the observer to readily locate the child comforter 100 in low light settings, such as during the night. The reflective material 109 may be applied to the shield 101, the button 103, or the handle 105 as well as combinations thereof.

In some embodiments, the reflective material 109 is applied to the front side 107 (i.e., the shield 101, the button 103, and/or the handle 105) using an adhesive.

In some embodiments, the reflective material 109 is molded into the material of the child comforter 100 such that the reflective material 109 is encased within the mold of the child comforter 100 as shown and described in FIG. 2.

The reflective material 109 is selected of a material which is reflective in the infrared spectrum. In another embodiments, the reflective material 109 may be reflective in the visual light spectrum.

In one example, a pacifier can contain reflective material 109 on the handle 105 or the shield 101 of the pacifier. Common place 3-piece pacifiers contain 3 basic parts: the shield 101, the button 103 and the elongated teat 200 (see FIG. 2). Reflective decorative elements can be printed onto the handle 105, button 103, or shield 101, which will provide the reflective property needed. The reflective material 109 used is not limited in type or kind and will be apparent to those skilled in the art. The reflective material 109 can completely cover the handle 105, button 103, or shield 101, but it is not necessary. A small portion of the button 103, such as the top or the rim, covered with reflective material 109 is sufficient to achieve the desired effect. The exact location or design of the reflective material 109 will be apparent to those skilled in the art. The reflective material 109 can be a coating. The reflective material 109 can also be covered by a coating. Further, the reflective material 109 can be coated on both sides creating a layered structure, to ensure food safety.

The child comforter 100 may include any shape, design, and configuration of pacifier and teether known in the arts. For example, the pacifier may be a single-piece construction or a three-piece construction. The shield 101 is dimensioned such that the child is unable to put the entire child comforter 100 in their mouth and thus cannot swallow and choke on the child comforter 100. The child comforter 100 may be constructed of various materials including rubber, plastic, or silicone and combinations thereof to allow the child to suckle or chew on the elongated teat.

FIG. 2 illustrates a cutaway view of the child comforter 100 having the reflective material 109 disposed within the interior of the shield 101 and the button 103 such that at least the front side 107 of the child comforter is visible on the display of a baby monitor in low light settings using an infrared camera. One skilled in the arts will readily understand that the reflective material 109 may be disposed within various elements of the child comforter 100. Further, various processes for disposing the reflective material 109 within the child comforter 100 may be employed such that the reflective material 109 is fully encased therein to protect against damage, removal, or tampering. An elongated teat 200 is positioned on the back side 202 of the child comforter 100 and is configured to extend into the child's mouth to be suckled and/or chewed on.

In one example, and in further reference to FIG. 2, the child comforter 100 is a 3-piece pacifier which can contain reflective material 109 on the handle 105, button 103, or the shield 101 of the pacifier. Common place 3-piece pacifiers contain three basic parts: the shield 101, the button 103 and the elongated teat 200. Reflective decorative materials can be printed onto the button 103 or shield 101, which will provide the reflective property needed. The reflective material 109 used is not limited in type or kind and will be apparent to those skilled in the art. The reflective material 109 can completely cover the button 103 or the shield 101, but it is not necessary. A small portion of the button 103, such as the top 204 or the rim 206, covered with reflective material 109 is sufficient to achieve the desired effect. The exact location or design of the reflective material 109 will be apparent to those skilled in the art. The reflective material 109 can be a coating. The reflective material 109 can also be covered by a coating 208. Further, the reflective material 109 can be coated on both sides creating a layered structure, to ensure food safety.

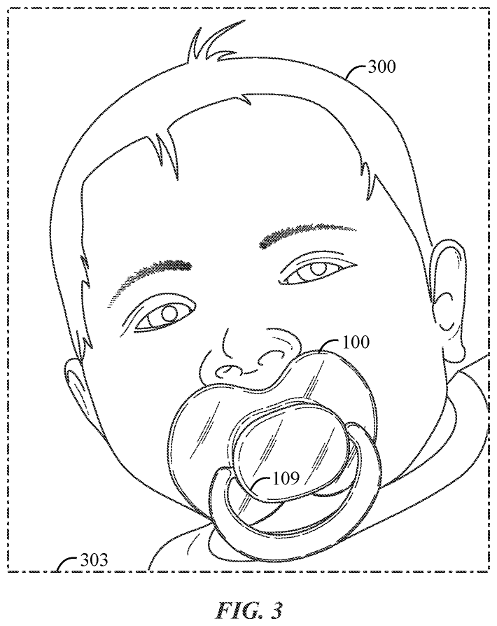

FIG. 3 illustrates a perspective view of the child 300 having the child comforter 100 disposed within their mouth as seen on the display 303 of a baby monitor having an infrared camera, such that the child comforter 100 is visible in low light settings. It is understood that the reflective material 109 in the above embodiments is placed at locations on or within the child comforter 100 that will not interfere with the safety of the child and will comply will all safety standards. While illustrated in use, the reflective material 109 is perhaps most useful when not in use to allow the parent or supervisor to readily locate the child comforter 100.

In some embodiments, the reflective material 109 is added as a sticker, which can be added during manufacturing or after. Reflective stickers added after manufacturing enable retrofitting of existing products. The sticker can be coated, to ensure safety standards are met.

In some embodiments, the child comforter 109 is a teether instead of a pacifier. The teether can have a similar construction as the pacifier above or it can be a single piece teether, which is common in the marketplace. Single piece teethers can be treated as single piece pacifier, which is discussed below.

In some embodiments, the child comforter 100 is a single-piece teether, such as a teething ring made of silicone or natural rubber. Reflective decorative elements can be printed onto child comforter 100 using food grade paints containing reflective elements. The reflective material 109 may cover the entire surface of a first side but may also only partially cover the first side. A small portion of the child comforter 100 covered with reflective material 109 is sufficient to achieve the desired effect of aiding the visibility of the child comforter 100 using an infrared camera. The exact location or design of the reflective material 109 will be apparent to those skilled in the art. Additionally, the reflective material 109 can also be incorporated into the material of the child comforter 100 itself, such as in a common multi-colored silicone teether. In such, the reflective materials 109 can be a dye or a pigment, which is incorporated into the silicone. The design and incorporation of reflective material 109 into materials such as silicone or natural rubber should be apparent to those skilled in the art.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A reflective child comforter, comprising:
a child comforter including a front side;
a reflective material arranged to reflect light from the front side.

2. The reflective child comforter of claim 1, wherein the reflective material is reflective in the infrared spectrum.

3. The reflective child comforter of claim 1, wherein the child comforter is configured as a pacifier.

4. The reflective child comforter of claim 3, wherein the pacifier is a three-piece pacifier.

5. The reflective child comforter of claim 3, wherein the pacifier is a single-piece pacifier.

6. The reflective child comforter of claim 1, wherein the child comforter is configured as a teether.

7. The reflective child comforter of claim 1, wherein the child comforter is comprised of a button and a shield.

8. The reflective child comforter of claim 7, wherein the reflective material is positioned on the shield.

9. The reflective child comforter of claim 8, wherein the reflective material is positioned on the button.

10. The reflective child comforter of claim 1, wherein the child comforter is further comprised of a handle wherein the reflective material is positioned on the handle.

11. The reflective child comforter of claim 1, wherein the reflective material is applied using an adhesive to the front side.

12. The reflective child comforter of claim 1, wherein the reflective material is embedded into the child comforter.

13. A reflective child comforter, comprising:
a child comforter including a front side having a button and a shield;
a reflective material arranged to reflect infrared light from at least a part of the front side; and
an elongated teat protruding from the back side to permit chewing or suckling.

14. The reflective child comforter of claim 13, wherein the reflective material is reflective in the infrared spectrum.

15. The reflective child comforter of claim 13, wherein the child comforter is configured as a pacifier or a teether.

16. The reflective child comforter of claim 13, wherein the reflective material is applied using an adhesive.

17. The reflective child comforter of claim 13, wherein the reflective material is embedded into the child comforter.

18. The reflective child comforter of claim 17, wherein the reflective material is a dye.

19. The reflective child comforter of claim 18, wherein the child comforter is constructed of silicone, plastic, a polymer, or natural rubber.

20. A reflective child comforter, comprising:
a child comforter configured to be positioned within a mouth, the child comforter including a front side having a button and a shield, and a back side having an elongated teat, the teat to permit chewing or suckling; and
a reflective material arranged to reflect infrared light from at least a part of the front side, the reflective material aiding the detection of the child comforter via an infrared camera.
